(19) United States
(12) Patent Application Publication
(10) Pub. No.: US 2020/0164908 A1
(43) Pub. Date: May 28, 2020

(54) ADJUSTABLE RACK TROLLEY

(71) Applicant: I JANG INDUSTRIAL CO., LTD., CHANGHUA COUNTY (TW)

(72) Inventor: Hsin-Yueh CHEN, CHANGHUA COUNTY (TW)

(21) Appl. No.: 16/200,734

(22) Filed: Nov. 27, 2018

(51) Int. Cl. B62B 3/02; B62B 3/00

(52) U.S. Cl. CPC B62B 3/022; B62B 3/005

(57) ABSTRACT

An adjustable rack trolley has a base seat, a top seat, a stand, and a supporting rod. The base seat has multiple sets of latching grooves arranged at spaced intervals along the first direction. The stand is connected with the base seat and the top seat, and has a first frame and a second frame pivotally connected to each other. An end of the first frame is pivotally connected to the first end of the base seat, and an end of the second frame is selectively engaged in a set of the latching grooves. An end of the top seat is pivotally connected to the top of the stand. One end of the supporting rod is pivotally connected to the top seat, and the other end of the supporting rod is detachably connected with the stand.

### BACKGROUND OF THE INVENTION

### 1. Field of the Invention

The present invention relates to a rack trolley, and more particularly to a rack trolley that is foldable and adjustable in height and inclination of a top seat.

### 2. Description of Related Art

Fruits and vegetables are usually displayed on racks for customers to choose and purchase easily. Conventional racks for displaying vegetables and fruits may include two types. One is height adjustment rack, and the inclination of the display frame of the rack is fixed. The other is angle adjustment rack, and the height of the display frame of the rack is fixed.

A conventional rack which may be adjusted both in height and inclination of the display frame usually has a huge size and is difficult to be moved and stored.

To overcome the shortcomings, the present invention tends to provide an adjustable rack trolley to mitigate or obviate the aforementioned problems.

### SUMMARY OF THE INVENTION

The main objective of the invention is to provide an adjustable rack trolley that is foldable and adjustable in height and inclination of the top seat.

The adjustable rack trolley in accordance with the present invention has a base seat, a top seat, a stand, and a supporting rod. The base seat has a first direction, a second direction perpendicular to the first direction, a first end and a second end being opposite each other and defined in the first direction, a latching portion and multiple wheels. The latching portion is mounted on the top of the base seat at a position near the second end, and has multiple sets of latching grooves formed in the top of the base seat and arranged at spaced intervals along the first direction. The wheels are mounted on the bottom of the base seat at spaced intervals.

The top seat is disposed above the base seat. The stand is connected with the base seat and the top seat, and has a first frame and a second frame. The frame and the second frame are pivotally connected with each other at the middle of the first frame and the second frame. An end of the first frame is pivotally connected to the first end of the base seat. An end of the second frame is selectivity engaged with one of the sets of the latching grooves. An end of the top seat is pivotally connected to a top of the stand. The supporting rod has two ends, and one of the ends of the supporting rod is pivotally connected to the bottom of the top seat, and the other end of the supporting rod has a connection element detachably connected with the stand.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an adjustable rack trolley in accordance with the present invention showing the adjustable rack trolley in a first connection position;

FIG. 1A is an enlarged perspective view of the adjustable rack trolley in FIG. 1;

FIG. 2 is another perspective view of the adjustable rack trolley in FIG. 1 showing the adjustable rack trolley in the first connection position;

FIG. 3 is a side view of the adjustable rack trolley in FIG. 1 showing the adjustable rack trolley in the first connection position;

FIG. 4 is a perspective view of the adjustable rack trolley in FIG. 1 showing the adjustable rack trolley folded;

FIG. 5 is another perspective view of the adjustable rack trolley in FIG. 4 showing the adjustable rack trolley folded;

FIG. 5A is an enlarged perspective view of the adjustable rack trolley in FIG. 5;

FIG. 5B is another enlarged perspective view of the adjustable rack trolley in FIG. 5;

FIG. 6 is a side view of the adjustable rack trolley in FIG. 5 showing the adjustable rack trolley folded;

FIG. 7 is a side view of the adjustable rack trolley in FIG. 1 showing the adjustable rack trolley in a second connection position;

FIG. 8 is a side view of the adjustable rack trolley in FIG. 1 showing the adjustable rack trolley in a third connection position;

FIG. 9 is a side view of the adjustable rack trolley in FIG. 1 showing the adjustable rack trolley in a fourth connection position; and

FIG. 10 is a side view of a second embodiment of an adjustable rack trolley in accordance with the present invention.

### DETAILED DESCRIPTION OF PREFERRED EMBODIMENT

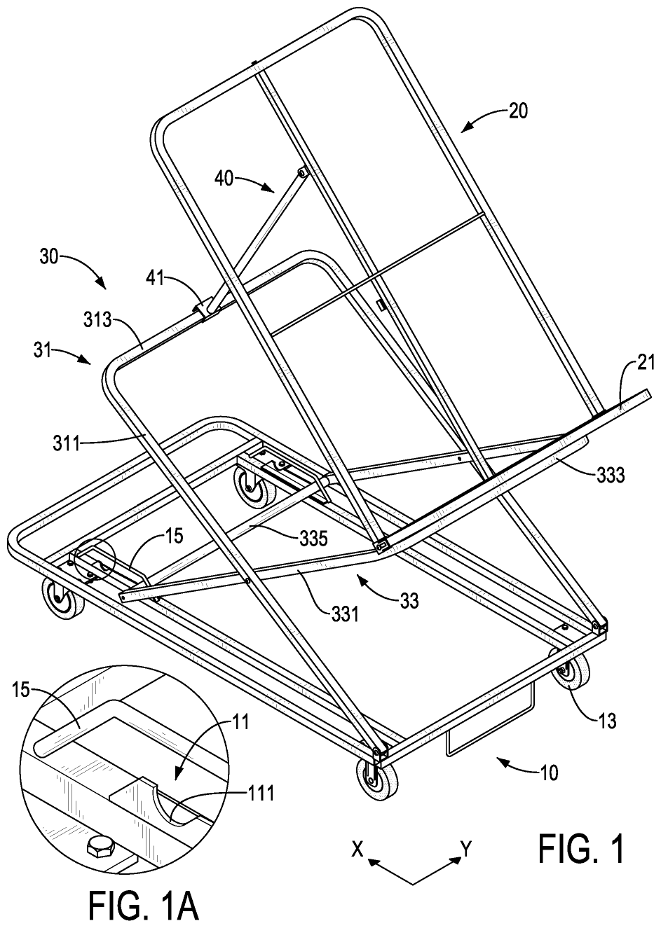

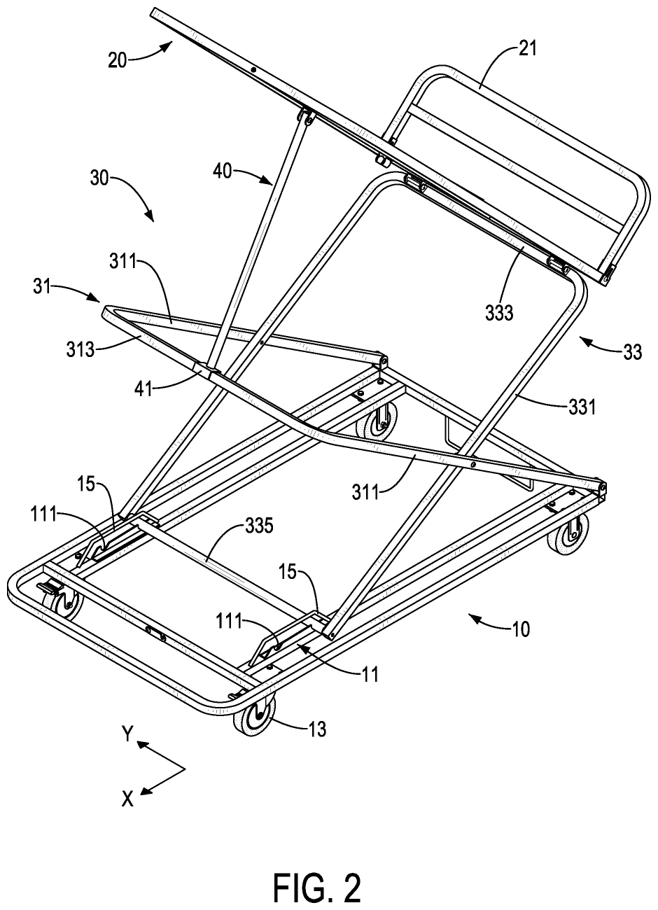

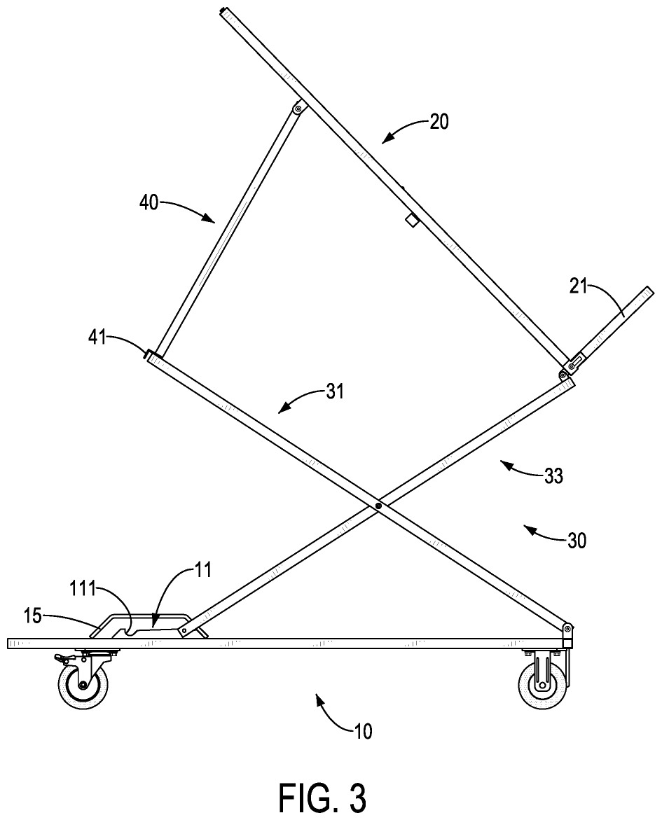

With reference to FIGS. 1 to 3, an adjustable rack trolley in accordance with the present invention comprises a base seat 10, a top seat 20, a stand 30, and a supporting rod 40.

The base seat 10 is a rectangular metal frame and has a first direction X, a second direction Y, a first end, a second end, a latching portion 11, and multiple wheels 13. The first direction X and the second direction Y are perpendicular to each other. The first end and the second end are defined in opposite ends of the first direction X. The latching portion 11 is mounted on the top of the base seat 10 at a position near the second end of the base seat 10, and has multiple sets of latching grooves 111 defined in the top of the base seat 10 and arranged at spaced intervals along the first direction X. Each set of the latching grooves 111 includes two corresponding latching grooves 111 arranged in the second direction Y. The wheels 13 are mounted on the bottom of the base seat 10 at spaced intervals, so the base seat 10 may be moved on the ground.

The top seat 20 is a rectangular metal frame, is deposed above the top of the base seat 10, and is applied for supporting a container with fruits and vegetables inside. Preferably, the top seat 20 has a guard frame 21 pivotally connected to an end of the top seat 20. The guard frame 21 may be turned in a guarding position where the guard frame 21 extends upward from the top seat 20 for supporting a side wall of the container, and turned in a folded position where the guard frame 21 is folded inside the top seat 20 for storage.

The stand 30 is connected with the base seat 10 and the top seat 20 and has a first frame 31 and a second frame 33. The first frame 31 and the second frame 33 are metal frames, and each has two ends, a middle, and two side rods 311, 331 arranged in opposite sides of the second direction Y. The first frame 31 has an end rod 313 connected with the two side rods 311 of the first frame 31 at a position away from the first end of the base seat 10. The second frame 33 has two end rods 333, 335 connected with the two side rods 331 of the second frame 33 and respectively arranged at opposite ends of the side rods 331. Each side rod 311 of the first frame 31 is pivotally connected with a respective one of the side rods 331 of the second frame 33 at the middles of the first frame 31 and the second frame 33. An end of the first frame 31 opposite the end rod 313 is pivotally connected to the first end of the base seat 10. The end rod 335 of the second frame 33 near the second end of the base seat 10 is a round rod, and is selectively engaged with one of the sets of the latching grooves 111. An end of the second frame 33 near the first end of the base seat 10 is pivotally connected to the end of the top seat 20 where the guard frame 21 of the top seat 20 is located. Preferably, the latching portion 11 of the base seat 10 has a limiting frame 15 mounted on the top of the base seat 10, and the end rod 335 of the second frame 33 and the latching grooves 111 are arranged inside the limiting frame 15 to limit a movable range of the second frame 33.

The supporting rod 40 has two ends, one end of the supporting rod 40 is pivotally connected to the bottom of the top seat 20, the other end of the supporting rod 40 has a connection element 41, and the connection element 41 is detachably connected with the end rod 313 of the first frame 31.

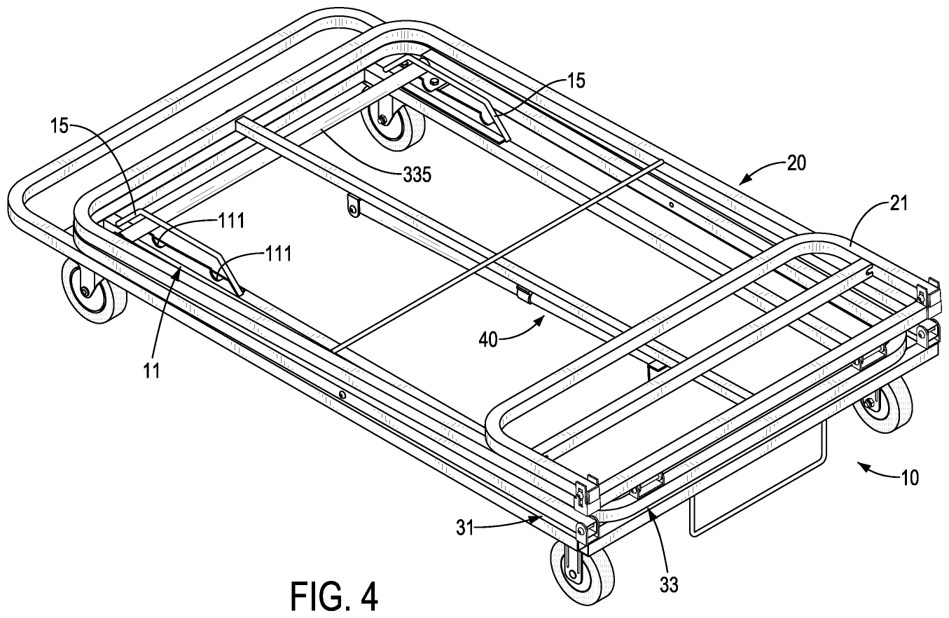

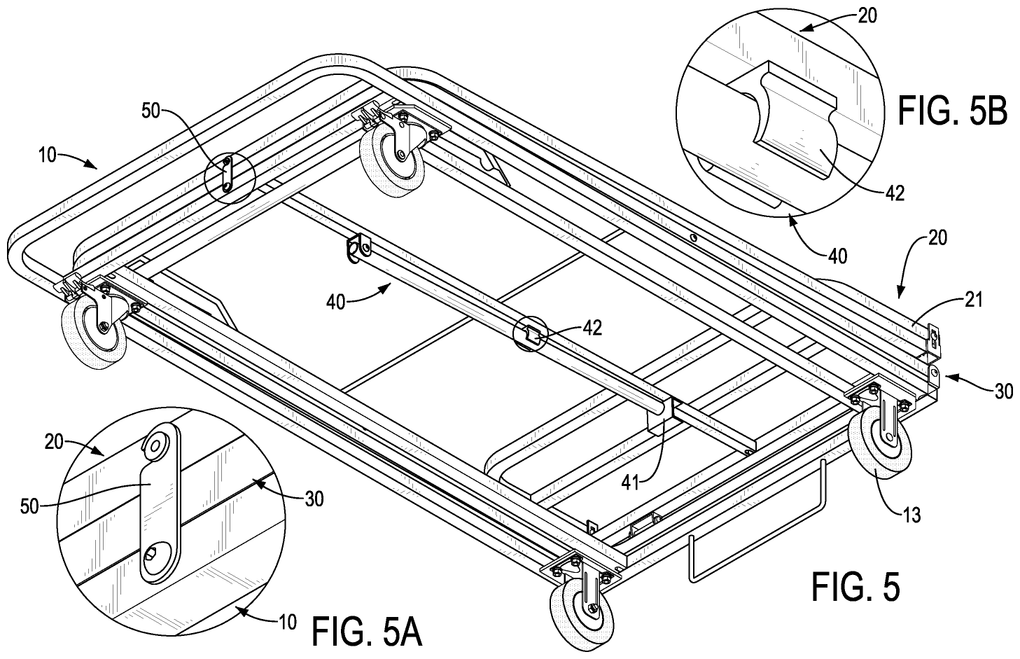

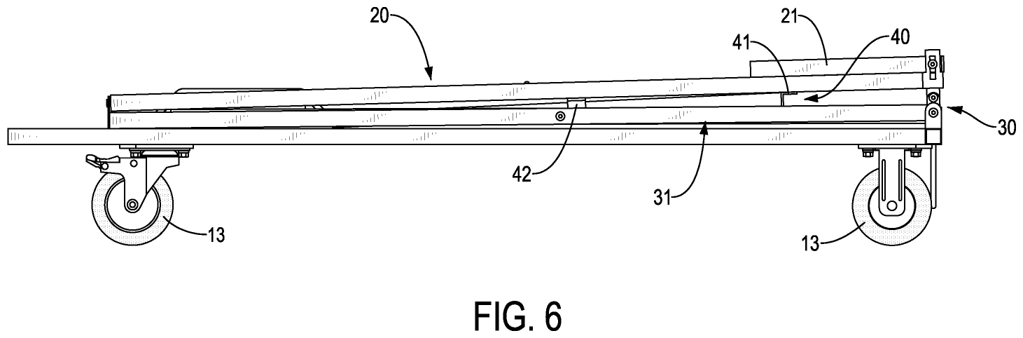

With reference to FIGS. 4 to 6, the adjustable rack trolley in accordance with the present invention is shown in a folded status. The end rod 335 of the second frame 33 is detached from the sets of latching grooves 111. The first frame 31 and the second frame 33 are relatively pivoted to a horizontally folded position and are stacked on the base seat 10. The supporting rod 40 is detached from the stand 30 and is folded in the bottom of the top seat 20. The top seat 20 is stacked on the stand 30, and the guard frame 21 is turned to the folded position and is folded inside the top seat 20. Because of the pivotally connections of the base seat 10, the top seat 20, the stand 30 and the supporting rod 40, the adjustable rack trolley may be folded to a minimum volume in the folded status. Preferably, a linking element 50 is detachably connected with the base seat 10 and the top seat 20 in the folded status to fix the positions of the top seat 20 and the stand 30. A clamping element 42 is mounted on the bottom of the top seat 20, and the supporting rod 40 may be detachably clamped by the clamping element after detaching from the stand 30.

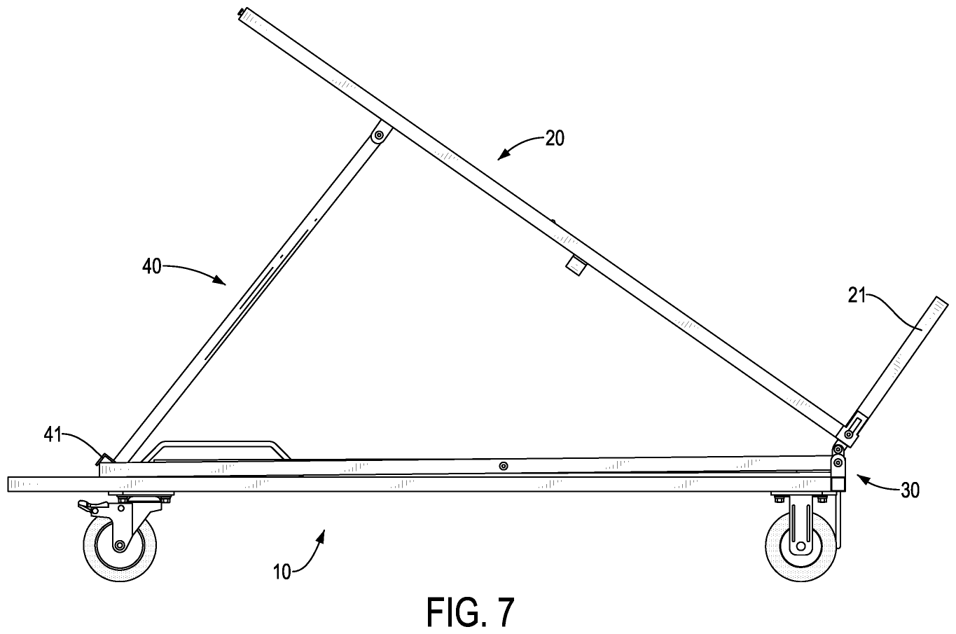

With reference to FIG. 7, the adjustable rack trolley is shown in a second connection position. The first frame 31 and the second frame 33 are relatively pivoted to a horizontally folded position and are stacked on the base seat 10. The connection element 41 of the supporting rod 40 is engaged with the end rod 313 of the first frame 31 to support the top seat 20 in an inclined position.

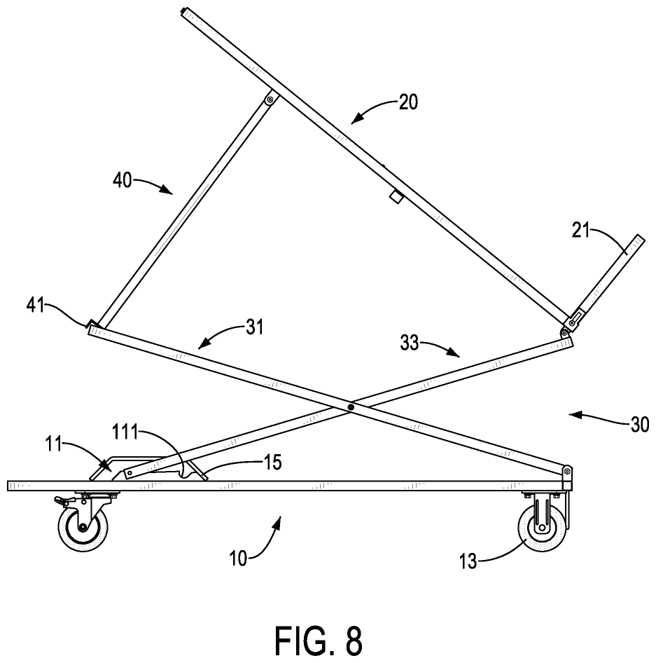

With reference to FIGS. 1, 3, and 8, a first connection position and a third connection position of the adjustable rack trolley are shown. The end rod 335 of the second frame 33 is engaged with one of the sets of the latching grooves 111, and the first frame 31 and the second frame 33 are relatively pivoted to form an X-shape and stand on the top of the base seat 10. The top seat 20 is moved upward and away from the base seat 10 with the stand 30. The distance between the end of the top seat 20 pivotally connected with the stand 30 to the base seat 10 is based on the distance between the set of the latching grooves 111 with which the second frame 33 is engaged to the first end of the base seat 10. When the distance between the set of the latching grooves 111 with which the second frame 33 is engaged to the first end of the base seat 10 is smaller, the distance between the end of the top seat 20 pivotally connected with the stand 30 to the base seat 10 is larger, and the relative height of the top seat 20 can be adjusted by adjusting the engaged position of the second frame 33 with one of the sets of the latching grooves 111.

In addition, the horizontal distance between the end rod 313 of the first frame 31 and the first end of the base seat 10 is based on the distance between the set of the latching grooves 111 with which the second frame 33 is engaged to the first end of the base seat 10. When the connection element 41 of the supporting rod 40 is connected to the end rod 313 of the first frame 31 to support the top seat 20 in an inclined position, the distance between the set of the latching grooves 111 with which the second frame 33 is engaged to the first end of the base seat 10 is smaller, and the inclined angle between the top seat 20 and the horizontal plane is larger.

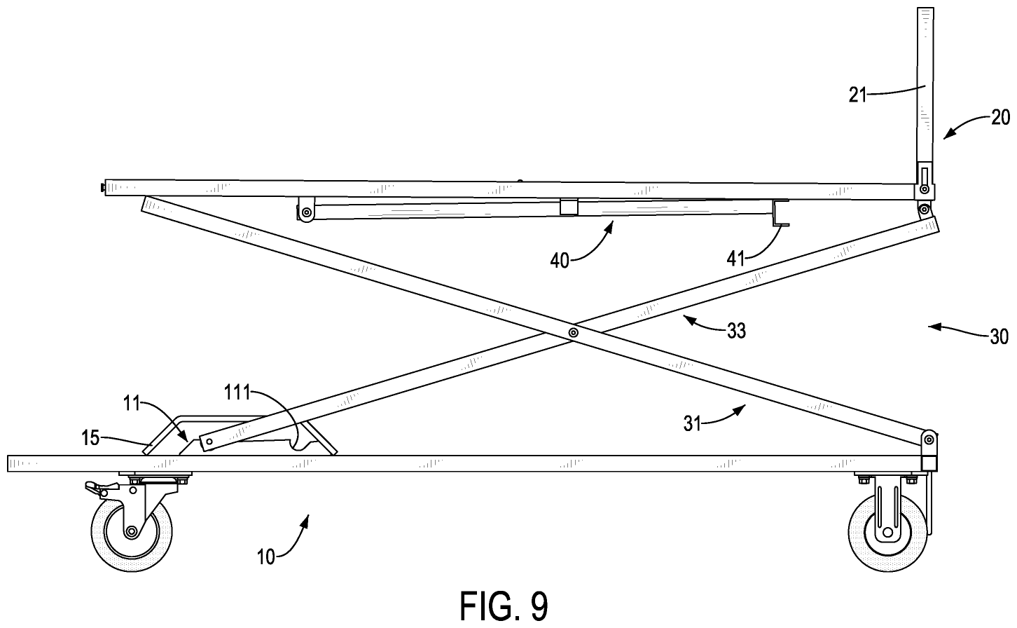

With reference to FIG. 9, the adjustable rack trolley is shown in a fourth connection position. The supporting rod 40 is detached from the stand 30, and the top seat 20 is turned to a horizontal position and is held on the stand 30. The distance between the top seat 20 and the base seat 10 may be adjusted by adjusting the engaged position of the second frame 33 with one of the sets of the latching grooves 111.

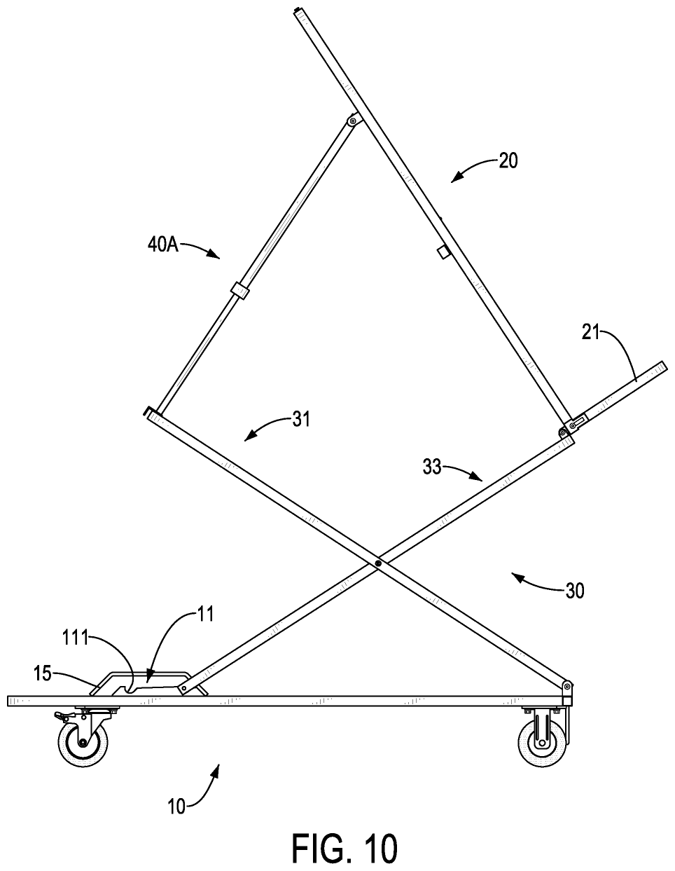

With reference to FIG. 10, a second embodiment of the adjustable rack trolley in accordance with the present invention is shown. In the second embodiment, the length of the supporting rod 40A is adjustable, and the inclined angle between the top seat 20 and the horizontal plane may be adjusted by adjusting the length of the supporting rod 40A.

In another embodiment, the stand 30 may have multiple end rods 313 arranged at spaced intervals along the first direction X, and the supporting rod 40 is selectively connected with one of the end rods 313. The inclined angle between the top seat 20 and the horizontal plane may be adjusted by adjusting the connected position of the supporting rod 40 with one of the end rods 313.

Preferably, each set of the latching grooves 111 may include one single latching groove 111 or multiple latching grooves 111 arranged in the second direction Y at intervals.

Alternatively, the top seat 20 may be pivotally connected to the end of the first frame 31 near the second end of the base seat 10, and the guard frame 21 is connected to the end of the top seat 20 where the top seat 20 is pivotally connected with the stand 30.

With such an arrangement, the adjustable rack trolley in accordance with the present invention has the following advantages and improvements:

1. Because the adjustable rack trolley in accordance with the present invention has multiple sets of the latching grooves 111 arranged at spaced intervals along the first direction X, the relative height of the top seat 20 may be adjusted by adjusting the engaged position of the second frame 33 with one of the sets of the latching grooves 111, and the relative inclined angle of the top seat 20 may be adjusted by the connection of the supporting rod 40 and the stand 30 while adjusting the relative height of the top seat 20.

2. The adjustable rack trolley is easy to store, move, pack and transfer, and may be folded to a minimum volume in the folded status by the pivotal connection of the base seat 10, the top seat 20, the stand 30 and the supporting rod 40.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjustable rack trolley comprising:
a base seat having
a top;
a bottom;
a first direction;
a second direction perpendicular to the first direction;
a first end and a second end being opposite each other in the first direction;
a latching portion mounted on the top of the base seat at a position near the second end and having multiple sets of latching grooves formed in the top of the base seat and arranged at spaced intervals along the first direction; and
multiple wheels mounted on the bottom of the base seat at spaced intervals;
a top seat disposed above the base seat, and having a bottom and two ends;
a stand connected with the base seat and the top seat and having
a first frame having two ends and a middle, and one of the ends of the first frame pivotally connected to the first end of the base seat; and
a second frame having two ends and a middle, the middle of the second frame pivotally connected to the middle of the first frame, and one of the ends of the second frame selectivity engaged with one of the sets of the latching grooves of the base seat, wherein one of the ends of the top seat is pivotally connected to a top of the stand; and
a supporting rod having two ends, and one of the ends of the supporting rod pivotally connected to the bottom of the top seat, and the other end of the supporting rod having a connection element detachably connected with the stand.

2. The adjustable rack trolley as claimed in claim 1, wherein the top seat is pivotally connected to one of the ends of the second frame of the stand near the first end of the base seat.

3. The adjustable rack trolley as claimed in claim 1, wherein the top seat has a guard frame pivotally connected to the end of the top seat that is pivotally connected to the top of the stand.

4. The adjustable rack trolley as claimed in claim 1, wherein the latching portion of the base seat further has a limiting frame, and the end of the second frame near the second end of the base seat and the sets of the latching grooves are arranged inside the limiting frame.

5. The adjustable rack trolley as claimed in claim 4, wherein a linking element is detachably connected with the base seat and the top seat.

6. The adjustable rack trolley as claimed in claim 5, wherein a clamping element is mounted on the bottom of the top seat, and the supporting rod is detachably clamped with the champing element.

7. The adjustable rack trolley as claimed in claim 6, wherein the top seat has a guard frame pivotally connected to the end of the top seat that is pivotally connected to the top of the stand.

8. The adjustable rack trolley as claimed in claim 7, wherein the top seat is pivotally connected to one of the ends of the second frame of the stand near the first end of the base seat.

9. The adjustable rack trolley as claimed in claim 8, wherein the supporting rod is adjustable in length.

10. The adjustable rack trolley as claimed in claim 1, wherein the supporting rod is adjustable in length.
